(19) United States
(12) Patent Application Publication
(10) Pub. No.: US 2013/0114314 A1
(43) Pub. Date: May 9, 2013

(54) CONVERTER SYSTEM AND POWER ELECTRONIC SYSTEM COMPRISING SUCH CONVERTER SYSTEMS

(71) Applicant: ABB TECHNOLOGY AG, Zurich (CH)

(72) Inventors: Peter STEIMER, Ehrendingen (CH); Oscar APELDOORN, Lengnau (CH)

(73) Assignee: ABB TECHNOLOGY AG, Zurich (CH)

(21) Appl. No.: 13/667,787

(22) Filed: Nov. 2, 2012

(30) Foreign Application Priority Data
Nov. 3, 2011 (EP) 11187642.1

(51) Int. Cl. H02H 7/10

(52) U.S. Cl. 363/50

(57) ABSTRACT

Exemplary embodiments are directed to a converter system having a phase voltage source, n partial converter systems, wherein n≧1 and, when n=1, the partial converter system is connected to the phase voltage source at a connection point and, when n>1, the partial converter systems are connected to the phase voltage source at the connection point. Furthermore, a power switch is connected in series between the phase voltage source and the connection point. An interruption element is connected in series between the phase voltage source, the power switch, and the connection point to rapidly switch off a fault current via a partial converter system. Furthermore, a power electronic system including m converter systems is specified, wherein m>1.

### RELATED APPLICATION

This application claims priority under 35 U.S.C. §119 to European Patent Application No. 11187642.1 filed in Europe on Nov. 3, 2011, the entire content of which is hereby incorporated by reference in its entirety.

### FIELD

The disclosure relates to the field of power electronics, such as a power electronic system including a converter system.

### BACKGROUND INFORMATION

Known converter systems are used in a large number of applications. A power electronic system including converter systems which can be simple to scale in terms of voltage is specified in DE 102005040543A1. The power electronic system in DE 102005040543A1 includes at least two phase components, wherein each phase component has a first and a second partial converter system. Each partial converter system includes an inductance and, connected in series therewith, n series-connected two-pole switching cells, wherein n≧2 and each switching cell has drivable bidirectional power semiconductor switches having a controlled unidirectional current-carrying direction and a capacitive energy store. For each phase component, the inductance of the first partial converter system is connected in series with the inductance of the second partial converter system.

Furthermore, for each phase component, the connection point of the inductance of the first partial converter system to the inductance of the second partial converter system forms a phase terminal. An electrical AC voltage system, that is to say in each case a phase voltage source, or an electrical load can be connected to the phase terminals.

Furthermore, a power switch can be connected to the phase terminals, said power switch serving to disconnect an electrical AC voltage system usually connected to the power electronic system or an electrical load connected to the power electronic system for example in the case of a fault in a partial converter system of a phase component or else for maintenance purposes with regard to a converter system. FIG. 1 illustrates such a power electronic system in accordance with a known implementation.

In the case of a fault in a partial converter system of a phase component, the resulting fault current can flow via the affected phase terminal from or into the electrical AC voltage system or from or to the electrical load before the power electronic system is isolated at the phase terminals by the power switch. Until this isolation is effected, the converter systems, in for example the components of the converter systems, and thus the power electronic system can incur damage, such that the converter systems have to be repaired or maintained and availability decreases.

### SUMMARY

An exemplary converter system is disclosed, comprising: a phase voltage source; n partial converter systems, wherein n≧1 and, when n=1, the partial converter system is connected to the phase voltage source at a connection point and, when n>1, the partial converter systems are connected to the phase voltage source at the connection point; a power switch connected in series between the phase voltage source and the connection point; and an interruption element connected in series between the phase voltage source, the power switch, and the connection point.

An exemplary converter system is disclosed comprising: a phase voltage source; n partial converter systems, wherein n≧1 and, when n=1, the partial converter system is connected to the phase voltage source at a connection point and, when n>1, the partial converter systems are connected to the phase voltage source at the connection point; a power switch connected in series between the phase voltage source and the connection point; an interruption element connected in series between the phase voltage source, the power switch, and the connection point; and m converter systems, where m>1, and the phase voltage sources of the converter systems are at a definable voltage potential.

### BRIEF DESCRIPTION OF THE DRAWINGS

FIG. 1 shows a power electronic system in accordance with a known implementation;

FIG. 2 shows a first converter system in accordance with an exemplary embodiment of the present disclosure;

FIG. 3 shows a second converter system in accordance with an exemplary embodiment of the present disclosure;

FIG. 4 shows a first power electronic system in accordance with an exemplary embodiment of the present disclosure;

FIG. 5 shows a second power electronic system in accordance with an exemplary embodiment of the present disclosure;

FIG. 6 shows a third power electronic system in accordance with an exemplary embodiment of the present disclosure;

FIG. 7 shows a first switching cell of the converter system in accordance with an exemplary embodiment of the present disclosure; and

FIG. 8 shows a second switching cell of the converter system in accordance with an exemplary embodiment of the present disclosure.

The reference signs used in the drawing and their meanings are summarized in the List of reference signs. In principle, identical parts are provided with identical reference signs in the figures. The embodiments described constitute examples of the subject matter of the disclosure and have no restrictive effect.

### DETAILED DESCRIPTION

Exemplary embodiments of the present disclosure specify a converter system in which improved control of a fault current occurring in the case of a fault in a partial converter system of the converter system is possible. Exemplary embodiments disclosed herein also specify a power electronic system including converter systems which can be realized simply and modularly.

According to an exemplary embodiment of the present disclosure, the converter system according to the disclosure includes a phase voltage source and n partial converter systems, wherein n≧1 and, in the case of n=1, the partial converter system is connected to the phase voltage source at a connection point and, in the case of n>1, the partial converter systems are connected to the phase voltage source at the connection point. In addition, a power switch is connected in series between the phase voltage source and the connection point. According to an exemplary embodiment disclosed herein, an interruption element can be connected in series between the phase voltage source, the power switch and the connection point, which element allows a fault current which occurs and which flows via a partial converter system, for example on account of a fault in a partial converter system, to be interrupted rapidly and reliably before the power switch isolates the phase voltage source. Consequently, a fault current which occurs in the case of a fault for example in a partial converter system can be controlled in a simple manner before the power switch performs the final disconnection.

An exemplary power electronic system according to the present disclosure includes m of the above-mentioned converter systems according to the disclosure, wherein m>1 and the phase voltage sources of the converter systems are at a definable voltage potential, in order advantageously to achieve a common and defined potential reference point of the phase voltage sources. Since, for each converter system, the interruption element is connected in series between the phase voltage source, the power switch and the connection point, there is the possibility of interrupting a fault current which flows only via one partial converter system of a converter system or a plurality of partial converter systems of a converter system, without the interruption elements of the other converter systems having to carry out an interruption. It is thus possible to continue to operate the power electronic system with the converter systems not affected by the fault current. As should be evident, there is always the possibility of carrying out a complete isolation by means of all the interruption elements and thus bringing about a safe state of the entire power electronic system. A fault current which occurs in the case of a fault in one partial converter system or in a plurality of partial converter systems of one or more converter systems can also be controlled in a simple manner before the power switch carries out the final disconnection.

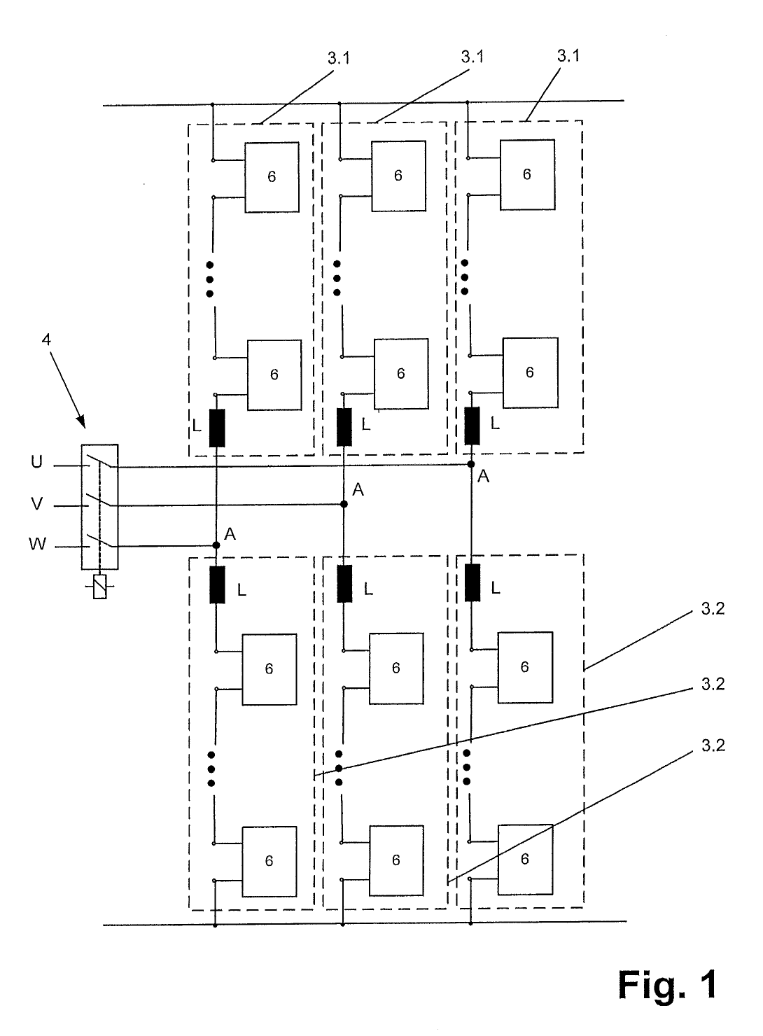

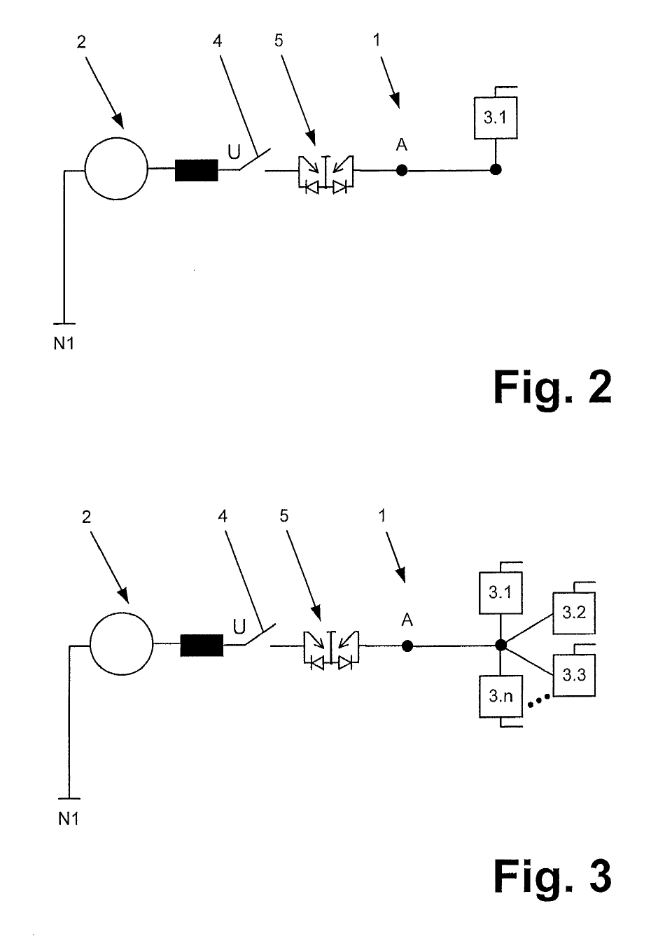

FIG. 1 shows a power electronic system in accordance with a known implementation. FIG. 2 shows a first converter system in accordance with an exemplary embodiment of the present disclosure. FIG. 3 shows a second converter system in accordance with an exemplary embodiment of the present disclosure. The converter system 1 according to FIG. 2 and FIG. 3 includes a phase voltage source 2 and n partial converter systems 3.1, . . . , 3.n, when n≧1. In the case of n=1, as shown by way of example in FIG. 2, the partial converter system 3 is connected to the phase voltage source 2 at a connection point A. In the case of n>1, as shown by way of example in FIG. 3, the partial converter systems 3.1, . . . , 3.n are then connected to the phase voltage source 2 at the connection point A. Furthermore, in accordance with FIG. 2 and FIG. 3, a power switch 4 is connected in series between the phase voltage source and the connection point.

According to the another exemplary embodiment of the present disclosure, an interruption element 5 is connected in series between the phase voltage source 2, the power switch 4 and the connection point A, which interruption element 5 allows a fault current which occurs and which flows via a partial converter system 3.1, . . . , 3.n, for example on account of a fault in a partial converter system 3.1, . . . , 3.n, to be interrupted rapidly and reliably before the power switch 5 isolates the phase voltage source 2. Accordingly, a fault current which occurs in the case of a fault for example in a partial converter system 3.1, . . . , 3.n can be controlled in a simple manner before the power switch 4 performs the disconnection of the phase voltage source 2. The power switch 4 can be embodied as a mechanical switch.

The exemplary interruption element 5 can be formed by a drivable switch having a bidirectional current-carrying direction, such that fault currents of different polarity can advantageously be interrupted.

The drivable switch having a bidirectional current-carrying direction can be embodied as a mechanical switch having pyrotechnic triggering. As shown by way of example in FIG. 2 and FIG. 3, however, the drivable switch having a bidirectional current-carrying direction can also be formed by two drivable bidirectional power semiconductor switches having a controlled unidirectional current-carrying direction, said switches being reverse-connected in parallel. The respective drivable bidirectional power semiconductor switch having a controlled unidirectional current-carrying direction in turn can have an insulated gate bipolar transistor and a diode reverse-connected in parallel with the bipolar transistor. In another exemplary embodiment, the respective drivable bidirectional power semiconductor switch can have a power MOSFET with a diode reverse-connection in parallel therewith.

As shown by way of example in FIG. 3, an exemplary drivable bidirectional power semiconductor switch can have a controlled unidirectional current-carrying direction to have a reverse blocking thyristor. In this case, any types of thyristors known to the person skilled in the art are conceivable, for example including integrated gate commutated thyristors (IGCT). Since only thyristors are used, this exemplary embodiment of the interruption element 5 can be constructed simply and is thus robust and cost-effective to realize. Furthermore, in another exemplary embodiment, the respective drivable bidirectional power semiconductor switch having a controlled unidirectional current-carrying direction to have a symmetrical insulated gate bipolar transistor (IGBT).

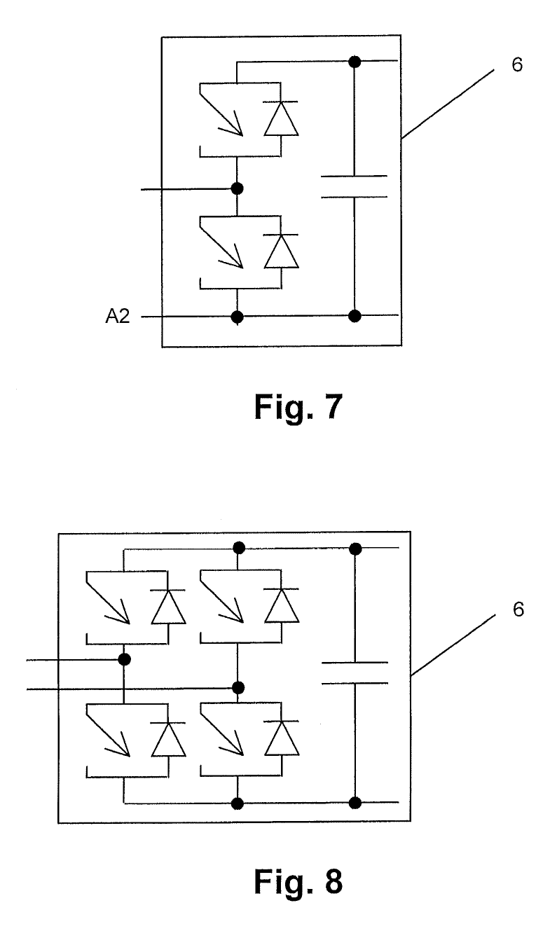

The partial converter system 3.1, . . . , 3.n includes an inductance L and, connected in series therewith, p series-connected two-pole switching cells 6, wherein p≧2 and each switching cell 6 has drivable bidirectional power semiconductor switches having a controlled unidirectional current-carrying direction and a capacitive energy store. The partial converter system 3.1, . . . , 3.n is connected to the connection point A by the inductance L. The respective drivable bidirectional power semiconductor switch having a controlled unidirectional current-carrying direction of the switching cells 6 of the partial converter system 3.1, . . . , 3.n is embodied, for example, as a gate turn-off thyristor (GTO) or as an integrated gate commutated thyristor (IGCT) with a respective diode reverse-connected in parallel. However, according to an exemplary embodiment of the present disclosure, a drivable bidirectional power semiconductor switch can have a controlled unidirectional current-carrying direction implemented through a power MOSFET with a diode additionally reverse-connected in parallel or as in insulated gate bipolar transistor (IGBT) with a diode additionally reverse-connected in parallel. FIG. 7 shows a first switching cell of the converter system in accordance with an exemplary embodiment of the present disclosure. As shown in FIG. 7, the drivable bidirectional power semiconductor switches have a controlled unidirectional current-carrying direction are interconnected in a half-bridge circuit and the capacitive energy store is connected in parallel with the half-bridge circuit.

FIG. 8 shows a second switching cell of the converter system in accordance with an exemplary embodiment of the present disclosure. As shown in FIG. 8, the drivable bidirectional power semiconductor switches having a controlled unidirectional current-carrying direction are interconnected in a full-bridge circuit and the capacitive energy store is connected in parallel with the full-bridge circuit.

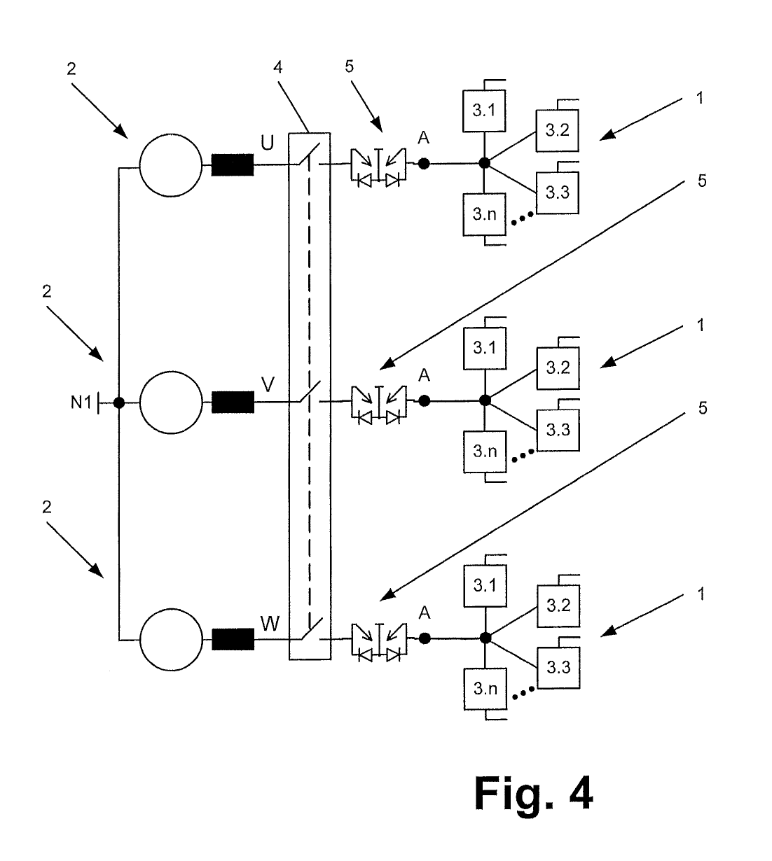

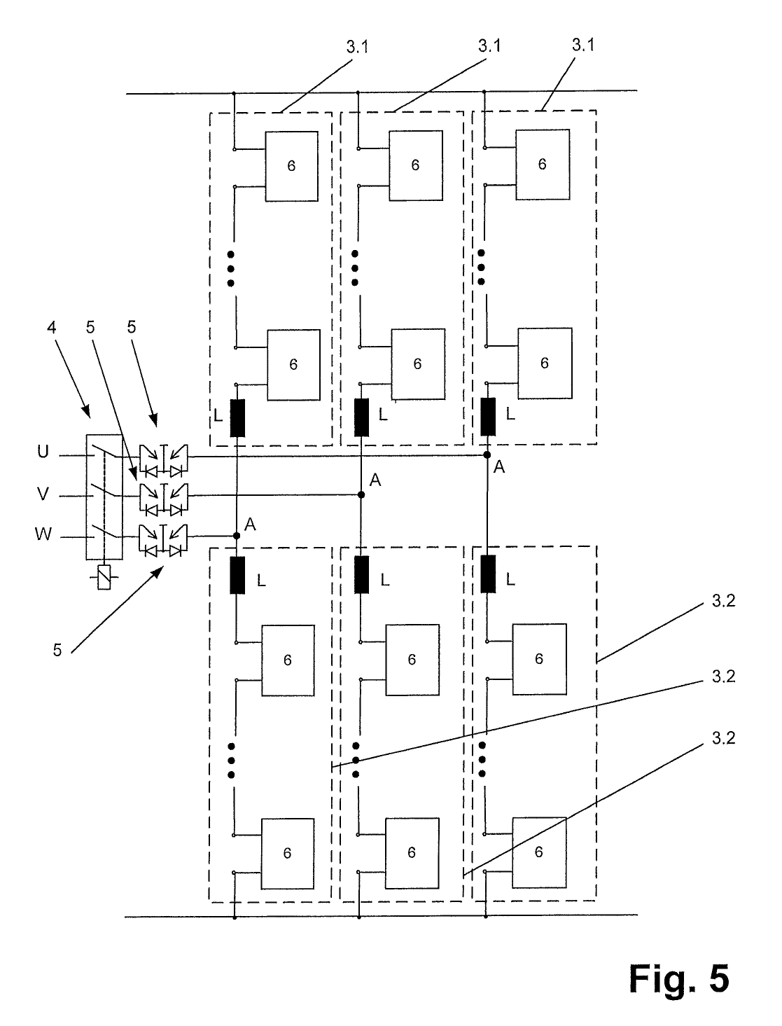

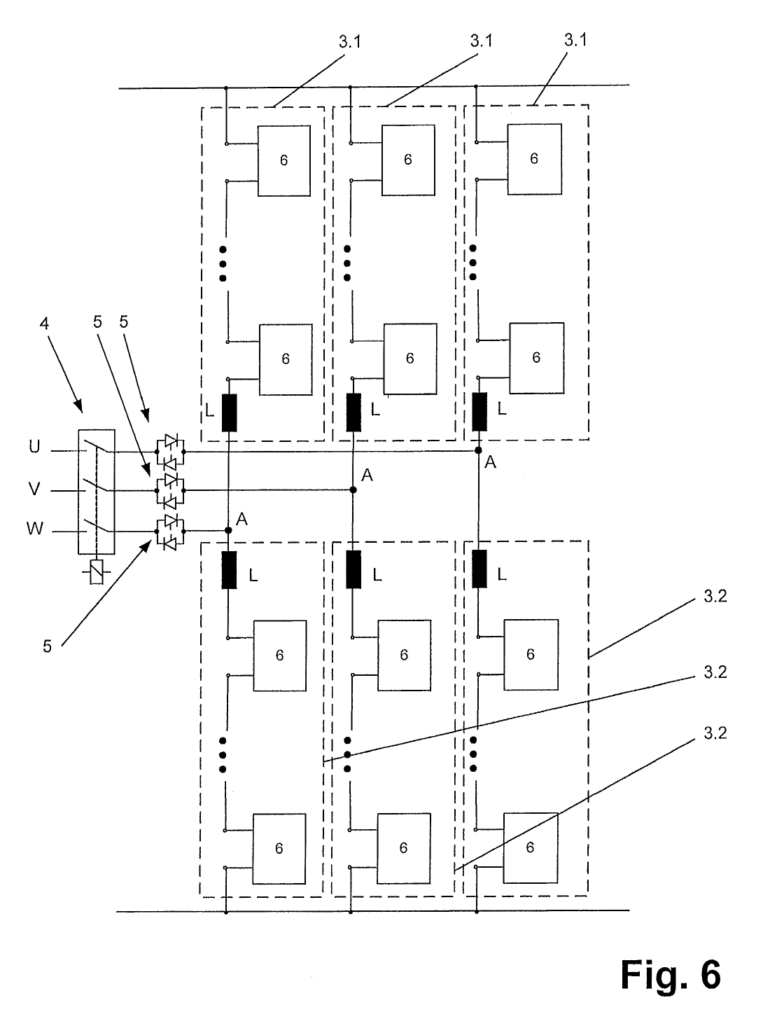

FIG. 4 shows a first power electronic system in accordance with an exemplary embodiment of the present disclosure. FIG. 5 shows a second power electronic system in accordance with an exemplary embodiment of the present disclosure. FIG. 6 shows a third power electronic system in accordance with an exemplary embodiment of the present disclosure. An exemplary power electronic system according to the present disclosure includes m of the above-mentioned exemplary converter systems 1, wherein m>1 and the phase voltage sources 2 of the converter systems 1 are at a definable voltage potential N1, as a result of which a common and defined potential reference point of the phase voltage sources 2 can advantageously be achieved. FIG. 5 and FIG. 6 illustrate by way of example m=3 converter systems 1, wherein each converter system 1 has n=2 partial converter systems 3.1, 3.2. For the sake of clarity, the phase voltage sources 2 of the converter systems 1 are not illustrated. An exemplary power electronic system according to the present disclosure is therefore constructed in a simple and modular manner and can be scaled simply with regard to the electrical power. Since, for each converter system 1, the interruption element 5 is connected in series between the phase voltage source 2, the power switch 4 and the connection point A, there is the possibility of interrupting a fault current which flows only via one partial converter system 3.1, . . . , 3.n of a converter system 1 or a plurality of partial converter system 3.1, . . . , 3.n of a converter system 1, without the interruption elements 5 of the other converter systems 1 having to carry out an interruption. It is thus possible to continue to operate the power electronic system with the converter systems 1 not affected by the fault current. According to exemplary embodiments described herein, a complete isolation can be carried out by means of all the interruption elements 5 and thus of transferring the entire power electronic system into a safe state. Overall, accordingly, a fault current which occurs in the case of a fault in one partial converter system 3.1, . . . , 3.n or in a plurality of partial converter systems 3.1, . . . , 3.n of one or more converter systems 1 can also be controlled in a simple manner before the power switch 4 carries out the final disconnection.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SIGNS

1 Converter system
2 Phase voltage source
3.1, . . . 3.n Partial converter system
4 Power switch
5 Interruption element
6 Switching cell
A Connection point
L Inductance
N1 definable potential

What is claimed is:

1. A converter system comprising:
a phase voltage source;
n partial converter systems, wherein n≧1 and, when n=1, the partial converter system is connected to the phase voltage source at a connection point and, when n>1, the partial converter systems are connected to the phase voltage source at the connection point;
a power switch connected in series between the phase voltage source and the connection point; and
an interruption element connected in series between the phase voltage source, the power switch, and the connection point.

2. The converter system as claimed in claim 1, wherein the interruption element is formed by a drivable switch having a bidirectional current-carrying direction.

3. The converter system as claimed in claim 2, wherein the drivable switch has bidirectional current-carrying direction and is formed by two drivable bidirectional power semiconductor switches having a controlled unidirectional current-carrying direction, said switches being reverse-connected in parallel.

4. The converter system as claimed in claim 3, wherein the respective drivable bidirectional power semiconductor switch having a controlled unidirectional current-carrying direction has an insulated gate bipolar transistor and a diode reverse-connected in parallel with the bipolar transistor, or the respective drivable bidirectional power semiconductor switch has a power MOSFET with a diode reverse-connected in parallel therewith.

5. The converter system as claimed in claim 3, wherein the respective drivable bidirectional power semiconductor switch having a controlled unidirectional current-carrying direction has a reverse blocking thyristor.

6. The converter system as claimed in claim 2, wherein the drivable switch having a bidirectional current-carrying direction is a mechanical switch having pyrotechnic triggering.

7. The converter system as claimed in claim 1, wherein the power switch is embodied as a mechanical switch.

8. The converter system as claimed in claim 2, wherein the power switch is embodied as a mechanical switch.

9. The converter system as claimed in claim 3, wherein the power switch is embodied as a mechanical switch.

10. The converter system as claimed in claim 4, wherein the power switch is embodied as a mechanical switch.

11. The converter system as claimed in claim 5, wherein the power switch is embodied as a mechanical switch.

12. The converter system as claimed in claim 1, wherein the partial converter system comprises an inductance and, connected in series therewith, p series-connected two-pole switching cells, p≧2 and each switching cell has drivable bidirectional power semiconductor switches having a controlled unidirectional current-carrying direction and a capacitive energy store, wherein the partial converter system is connected to the connection point by the inductance.

13. The converter system as claimed in claim 2, wherein the partial converter system comprises an inductance and, connected in series therewith, p series-connected two-pole switching cells, p≧2 and each switching cell has drivable bidirectional power semiconductor switches having a controlled unidirectional current-carrying direction and a capacitive energy store, wherein the partial converter system is connected to the connection point by the inductance.

14. The converter system as claimed in claim 3, wherein the partial converter system comprises an inductance and, connected in series therewith, p series-connected two-pole switching cells, p≧2 and each switching cell has drivable bidirectional power semiconductor switches having a controlled unidirectional current-carrying direction and a capacitive energy store, wherein the partial converter system is connected to the connection point by the inductance.

15. The converter system as claimed in claim 1, comprising:
m converter systems, where m>1, and the phase voltage sources of the converter systems are at a definable voltage potential.

16. The converter system as claimed in claim 2, comprising:
m converter systems, where m>1, and the phase voltage sources of the converter systems are at a definable voltage potential.

17. The converter system as claimed in claim 3, comprising:
m converter systems, where m>1, and the phase voltage sources of the converter systems are at a definable voltage potential.

18. The converter system as claimed in claim 4, comprising:
m converter systems, where m>1, and the phase voltage sources of the converter systems are at a definable voltage potential.

19. The converter system as claimed in claim 12, comprising:
m converter systems, where m>1, and the phase voltage sources of the converter systems are at a definable voltage potential.

20. A converter system comprising:
a phase voltage source;
n partial converter systems, wherein n≧1 and, when n=1, the partial converter system is connected to the phase voltage source at a connection point and, when n>1, the partial converter systems are connected to the phase voltage source at the connection point;
a power switch connected in series between the phase voltage source and the connection point;
an interruption element connected in series between the phase voltage source, the power switch, and the connection point; and
m converter systems, where m>1, and the phase voltage sources of the converter systems are at a definable voltage potential.
